(19) United States
(12) Patent Application Publication
(10) Pub. No.: US 2024/0232259 A1
(43) Pub. Date: Jul. 11, 2024

(54) JUST-IN-TIME MATERIALIZATION OF CLONED USERS IN COMPUTING ENVIRONMENTS WITHIN A DATABASE SYSTEM

(71) Applicant: Salesforce, Inc., San Francisco, CA (US)

(72) Inventor: Xiaodan WANG, San Francisco, CA (US)

(73) Assignee: Salesforce, Inc., San Francisco, CA (US)

(21) Appl. No.: 18/152,185

(22) Filed: Jan. 10, 2023

(51) Int. Cl. G06F 16/901; G06F 21/31

(52) U.S. Cl. CPC G06F 16/9014; G06F 21/31

(57) ABSTRACT

Users may be authorized to access a second software environment with a second limited set of authorized users. The second software environment may include at a first point in time prior to the user access a subset of a first software environment that includes at the first point in time a first set of authorized users that was a superset of the second limited set. A determination may be made as to whether a first user has potentially been a member of the first set of authorized users. The determination may be made via a global filtering process with at least one first hash value associated with a login attempt by the first user whether. Account information associated with the first user and at least the first software environment may be sent to the second software environment

### FIELD OF TECHNOLOGY

This patent document relates generally to database systems and more specifically to account management within software environments.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks.

Cloud computing services may be provided within the context of a software environment that unifies a set of computing resources. A software environment may be associated with a set of authorized users. At times, new software environments may be created. These new software environments may sometimes incorporate elements of existing software environments, such as existing user accounts. However, creating a new software environment based on an existing environment can be time intensive since it may require copying user account information for potentially many user accounts.

### BRIEF DESCRIPTION OF THE DRAWINGS

The included drawings are for illustrative purposes and serve only to provide examples of possible structures and operations for the disclosed inventive systems, apparatus, methods and computer program products for user account materialization. These drawings in no way limit any changes in form and detail that may be made by one skilled in the art without departing from the spirit and scope of the disclosed implementations.

FIG. 1 illustrates a user materialization overview method, performed in accordance with one or more embodiments.

FIG. 2 illustrates a software environment creation method, performed in accordance with one or more embodiments.

FIG. 3 illustrates one example of a software environment filter arrangement, configured in accordance with one or more embodiments.

FIG. 4 illustrates a method for user account identification, performed in accordance with one or more embodiments.

FIG. 5 illustrates one example of a software environment filter arrangement, configured in accordance with one or more embodiments.

FIG. 6 illustrates a just-in-time user materialization method, performed in accordance with one or more embodiments.

FIG. 7 illustrates a software environment deactivation method, performed in accordance with one or more embodiments.

FIG. 8 illustrates a method 800 for identifying a user account, performed in accordance with one or more embodiments.

FIG. 9 shows a block diagram of an example of an environment that includes an on-demand database service configured in accordance with some implementations.

FIG. 10A shows a system diagram of an example of architectural components of an on-demand database service environment, configured in accordance with some implementations.

FIG. 10B shows a system diagram further illustrating an example of architectural components of an on-demand database service environment, configured in accordance with some implementations.

FIG. 11 illustrates one example of a computing device, configured in accordance with one or more embodiments.

### DETAILED DESCRIPTION

Techniques and mechanism described herein provide for user materialization in a software environment. In many instances, a second software environment is created by partially or entirely copying one or more elements of a first software environment, such as the set of authorized user accounts. However, many users of the first software environment will never log in to the second software environment. User materialization refers to data copy and processing operations to ready a user account cloned from a first software environment for log in at a second software environment. For example, user materialization may involve modifying the username to avoid colliding with an existing username, copying data associated with a user account into a globally replicated table for authentication, and/or other types of operations.

In conventional systems, user materialization may increase the creation time for creating a second software environment based on a first software environment. For instance, copying user account data for many user accounts from the first software environment to the second software environment may take an inordinate amount of time, particular with environments that include millions of user accounts.

In conventional systems, high resource footprint may lead to high cost-to-serve. User materialization incurs both compute and storage costs on the system. Compute costs include operations such as readying the user account. Storage costs include those associated with persisting materialized users in a globally replicated table. Such costs may be incurred for each user account that is copied, despite the fact that most user accounts copied from a first software environment to a second software environment are never used since software environments are often created for development and testing rather than production access.

Some embodiments described herein provide for reduced software environment creation times and/or lower cost-to-serve associated with materializing users that will never log into the software environment. Instead of materializing all users, a small, bounded set of users may be materialized when initially creating the second software environment while materialization is deferred for all of the remaining users. A deferred user may be only materialized at a later point in time, for instance after the user attempts to login and use the second software environment for the first time.

In some embodiments, one or more local and/or global filters may be employed for efficient discovery and routing of login requests from non-materialized users to their intended software environment. An asynchronous event-driven and batch processing pattern may be applied for deferred user materialization to reduce the resource impact of materialization.

In some embodiments, one or more elements of a first software environment within an on-demand computing services environment may be copied into a second software environment, which may be hosted in a separate computing environment. Such functionality may allow, for instance, development and testing within the second software environment without adversely impacting the performance or data integrity of the first software environment.

Consider the example of Alex, a systems administrator for Acme corporation, which accesses cloud computing services via an on-demand computing services environment. Another administrator at Acme created a sandbox environment based on its production environment to test new software and configurations. Acme's environment is associated with many user accounts. When using a conventional system, creating the sandbox environment would take an inordinate amount of time were all of these user accounts materialized to the sandbox environment from the production environment. However, if Alex's account were not among those materialized, then an administrator would need to manually instruct the system to materialize her account to the sandbox environment when she would like to access the sandbox account, leading to delay in accessing the sandbox environment.

In contrast, using techniques and mechanisms described herein, Alex's account need not be materialized to the sandbox environment at the time it is created, saving time in sandbox environment creation. Then, when Alex attempts to access the sandbox environment, her initial login attempt may fail due to the fact that her account is not yet present in the sandbox environment. This failure may be detected by the on-demand computing services environment and may trigger the materialization of Alex's account to the sandbox environment so that her next login attempt succeeds. In this way, Alex may quickly access the sandbox environment without the necessity of manual intervention by a system administrator.

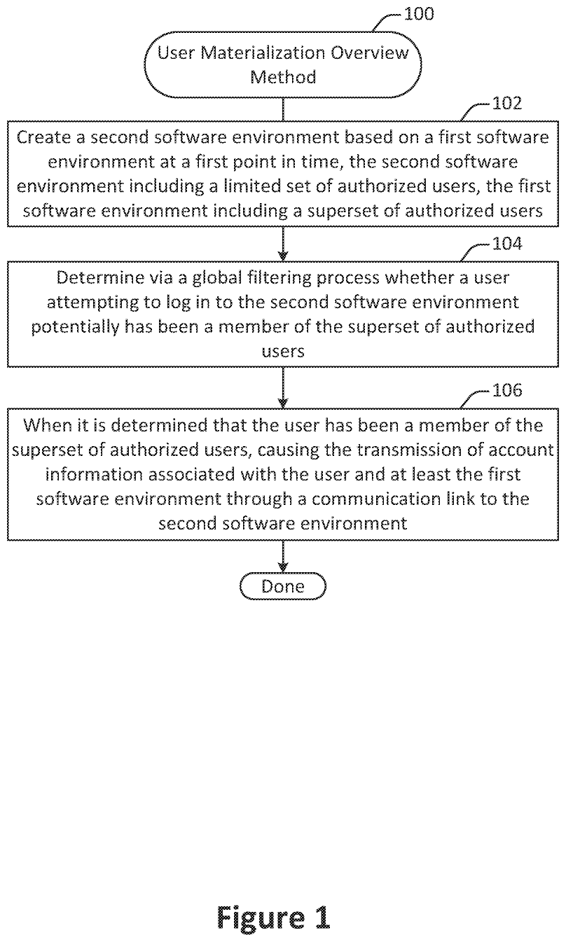

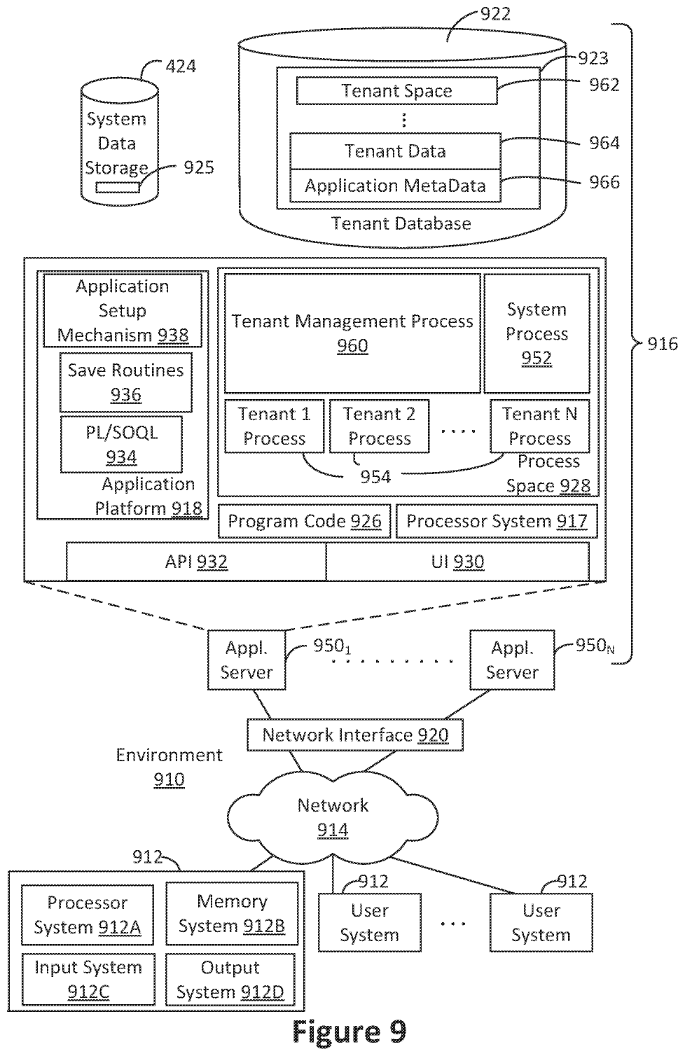

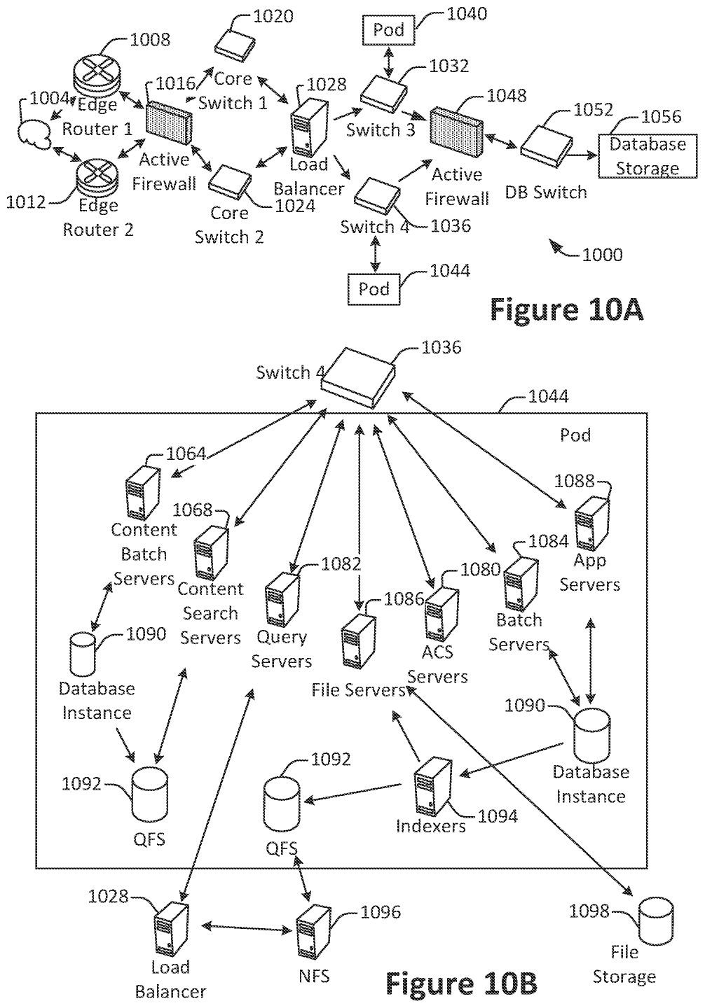

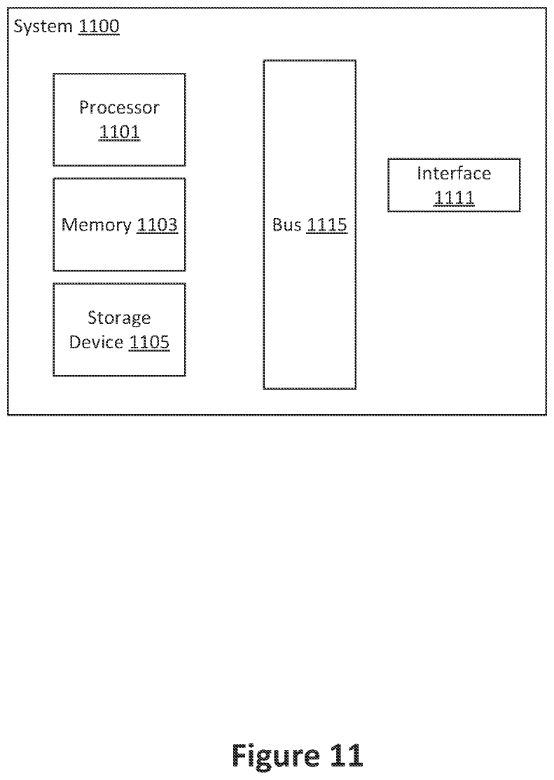

FIG. 1 illustrates a user materialization overview method 100, performed in accordance with one or more embodiments. The user materialization overview method 100 may be performed in order to materialize a user account from a first software environment the user is authorized to access to a second software environment. The user materialization overview method 100 may be performed on any suitable computing device, such as for instance one or more of the computing devices illustrated in the on-demand computing services environment shown in FIG. 9, FIG. 10A, FIG. 10B, and FIG. 11.

At 102, a second software environment is created based on a first software environment at a first point in time. The second software environment includes a limited set of authorized users. The first software environment includes a superset of authorized users that includes the limited set of authorized users.

In some embodiments, the second software environment may be a sandbox or replica of the first software environment. For example, the second software environment may replicate one or more elements of the first software environment for purposes such as testing. Elements of the first software environment that may be replicated may include, but are not limited to, one or more database tables, authorized users, configuration settings, metadata, data, and the like. However, the second software environment need not include all elements of the first software environment. Furthermore, the second software environment may include one or more elements that differ from the first software environment.

At 104, a determination is made via a global filtering process whether a user attempting to log in to the second software environment potentially has been a member of the superset of authorized users. In some embodiments, making the determination may involve determining one or more hash values associated with the user. For instance, one or more hash values may be computed based on a username or other identifier associated with the user.

In some embodiments, the global filtering process may involve querying a global filter, which may be probabilistic or non-probabilistic. For example, the global filter may be a bloom filter or a cuckoo filter configured to return a negative response if a user is not represented in the filter and a positive response if the user is potentially represented in the filter.

At 106, when it is determined that the user has been a member of the superset of authorized users, account information associated with the user and at least the first software environment is transmitted through a communication link to the second software environment. In some embodiments, determining whether the user has been a member of the superset of authorized users may involve applying a local filtering process that includes a filter identifying users associated with the second software environment. Alternatively, or additionally, a username may be decomposed to identify a portion that identifies the second software environment.

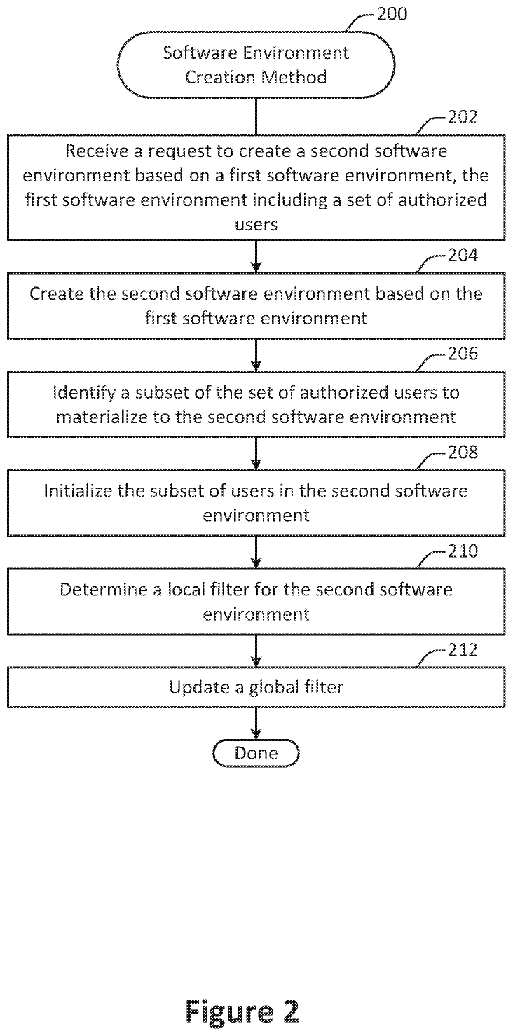

FIG. 2 illustrates a software environment creation method 200, performed in accordance with one or more embodiments. The method 200 may be performed on a computing system, such as one or more devices within an on-demand computing services environment of the type described with respect to FIG. 9, FIG. 10A, FIG. 10B, and FIG. 11.

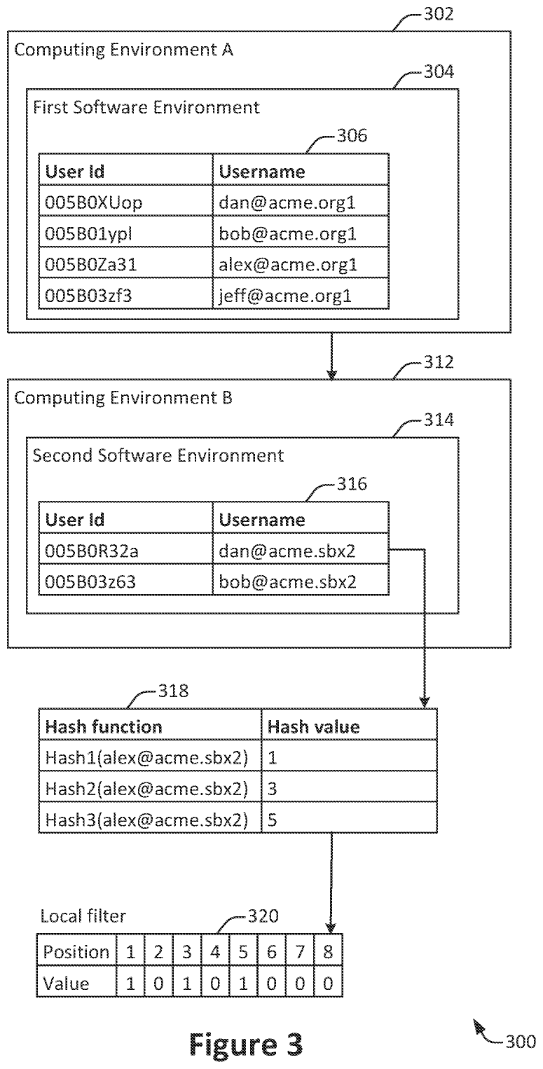

FIG. 2 is described in part with reference to FIG. 3, which illustrates one example of a software environment filter arrangement 300, configured in accordance with one or more embodiments. FIG. 3 includes a computing environment A 302, which in turn includes a first software environment 304. A computing environment may also be referred to herein as a pod. The first software environment 304 includes a set of authorized users 306. FIG. 3 also includes a computing environment B 312, which in turn includes a second software environment 314. The second software environment 314 includes a set of materialized users 316, which is processed at 318 to yield a local filter 320.

A request to create a second software environment based on a first software environment is received at 202. In some embodiments, the request may be generated based on user input. For instance, an administrator may provide a request to create a sandbox environment based on a source environment. Alternatively, or additionally, one or more software environments may be created programmatically, for instance based on one or more scripts or configuration parameters.

According to various embodiments, a software environment may include a collection of computing resources (not shown in FIG. 3) within an on-demand computing services environment. The software environment may be linked with an entity such as an organization accessing computing services via the on-demand computing services environment. The software environment may include resources such as database storage, file storage, software services, configuration settings, user accounts, and the like.

According to various embodiments, a software environment may include a set of authorized users, such as the set of authorized users of the first software environment. For example, in FIG. 3, a set of authorized users for the first software environment is shown at 306. An authorized user may include a collection of information such as a username, a user ID, a password, and/or user metadata. For instance, metadata may include information such as a name, address, birth date, organizational role, organization affiliation, and/or any other suitable information.

In some implementations, a software environment may be associated with potentially many user accounts. For instance, in a configuration in which a software environment is associated with a large organization that stores user account information associated with many individuals, a single software environment may include millions or billions of user accounts. However, for the purpose of illustration, only four accounts are shown in FIG. 3.

The second software environment is created based on the first software environment at 204. In some embodiments, creating the second software environment may include copying one or more elements of the first computing environment. For instance, the second computing environment may be set up to test one or more elements related to the first computing environment. Thus, the second computing environment may copy one or more elements such as data, configuration settings, and/or user accounts from the first computing environment.

In some implementations, the second software environment may be created within a containing computing environment. For instance, in FIG. 3, the second software environment 314 may be created for Acme corporation within the computing environment 312. The computing environment 312 may include some number of software environments that share resources such as one or more databases, load balancers, task schedulers, processors, communication interfaces, connection pools, and/or other such computing elements.

In some embodiments, the second computing environment may diverge from the first computing environment over time. For example, the first computing environment may include one or more user accounts that are copied to the second computing environment. Over time, details related to those user accounts on the first computing environment may change, and those details may not be reflected on the second computing environment. As another example, all or a portion of data associated with the first computing environment may be copied to the second computing environment. Subsequently such data may change over time on the first computing environment, causing the data on the two environments to diverge. Alternatively, in some configurations some or all of the subsequent changes made to the first computing environment may be propagated to the second computing environment.

A subset of the set of authorized users to materialize to the second software environment is identified at 206. In FIG. 3, for example, the subset of the set of authorized users to materialized to the second software environment is shown at 316 and includes the first two users of the set of authorized users 306 of the first software environment 304.

In some embodiments, one or more users of the set of authorized users may be identified based on user input. For instance, an administrator associated with the request to create the second software environment may provide a configuration file or other selection mechanism identifying the subset of the set of authorized users.

In some embodiments, one or more users of the set of authorized users may be identified automatically. For instance, one or more configuration parameters may be consulted to identify one or more users. Automatically selected users may include, for example, one or more systems administrators or other special accounts associated with the on-demand computing services environment, the first software environment, and/or the second software environment.

The subset of users is initialized in the second software environment at 208. According to various embodiments, initializing the subset of users may involve copying some or all of the information associated with the subset of users from the first software environment to the second software environment. According to various embodiments, as discussed herein, a user account may be associated with a wide range of information. However, for the purpose of illustration, only a user ID and username are shown in FIG. 3.

In some embodiments, initializing (also referred to herein as materializing) the subset of users to the second software environment may involve changing one or more elements associated with the account information. For instance, a username of dan@acme.org1 in the first software environment may be associated with a username of dan@acme.sbx2 in the second software environment. Such changes may be strategically determined based on, for instance, account naming conventions associated with the on-demand computing services environment.

A local filter for the second software environment is determined at 210. In some embodiments, the local filter may be a bloom filter. Alternatively, a different type of filter may be used, such as a cuckoo filter. The local filter may be used to help determine whether a failed login request is associated with a user account that is authorized to access the second software environment but that has not yet been materialized to the second software environment.

In some embodiments, the local filter may be specific to the second software environment 314. Alternatively, or additionally, a filter that is specific to a larger environment, such as the computing environment 312 in which the second software environment resides, maybe maintained.

An example of determining a local filter configured as a bloom filter is shown at 318 and 320. However, a filter configured in a different way may involve different operations. At 318, a number of hash functions are applied to the username alex@acme.sbx2, which is an account that was not materialized to the second software environment 314 but that is authorized under username alex@acme.org1 to access the first software environment in the authorized user table 306.

According to various embodiments, various numbers of hash functions may be applied. Different hash functions may be the same function initialized with different values. Alternatively, entirely different hash functions may be used. A hash function may map an input value to a fixed-size value. Examples of suitable hash functions include, but are not limited to: SHA-1, Sha-2, SHA-3, MD5, and CRC32.

According to various embodiments, the number and type of hash functions, the fixed-size value of the hash functions, and other such configuration parameters may be strategically determined based on characteristics such as the anticipated or actual number of user accounts, the cost of hash collisions, the local filter size, and the global filter size, and/or any other relevant considerations. For instance, increasing the fixed output size of the hash functions may decrease the frequency of false positives returned by the filter at the expense of increasing the filter size.

The bloom filter 320 is then updated based on the hash values. Because the hash values output by the hash functions included a 1, a 3, and a 5, bits in the bloom filter corresponding to those hash values are set to 1 if they have not been set to 1 already.

A global filter is updated at 212. In some embodiments, the global filter may be computed as a superset of the local filter. That is, the global filter may reflect non-materialized users from more than one software environment.

In some implementations, the global filter may be determined using similar configuration parameters as the local filter. Alternatively, different configuration parameters may be used for the global filter. For instance, the global filter may include a different number of hash functions, a different hash value output size, and/or other differences relative to the local filter.

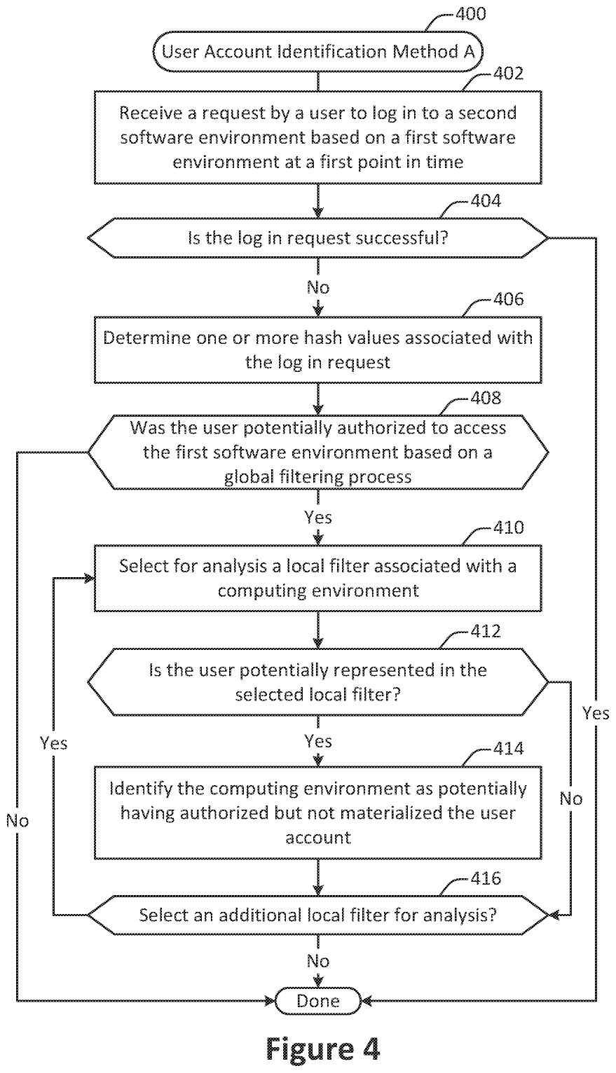

FIG. 4 illustrates a method 400 for user account identification, performed in accordance with one or more embodiments. According to various embodiments, the method 400 may be performed in order to identify whether a user account that is not present on a software environment is invalid or whether instead it is a valid account that has not yet been materialized to the software environment.

In some embodiments, the method 400 may be performed at one or more computing devices within an on-demand computing services environment. For instance, the method 400 may be performed at one or more elements shown within FIG. 9, FIG. 10A, FIG. 10B, and FIG. 11.

At 402, a request is received by a user to log in to a second software environment based on a first software environment at a first point in time. In some embodiments, the request may be received at a communication interface from a client machine via a network such as the internet. The request may be received in the context of a communication session. The request may include elements such as an account identifier (e.g., a username) and a password.

A determination is made at 404 as to whether the log in request is successful. According to various embodiments, the manner in which a determination is made as to whether the log in request is successful may depend on the particular authentication scheme employed. For instance, in many systems a password is hashed to produce a hash value using a cryptographic hash function. This hash value is then compared against a hash value stored in a database table that links usernames with hashed passwords. If the hash value matches the value corresponding to the username in the database table, then the login request is successful.

In some embodiments, the identification of a user account may be triggered by the failure of a login attempt, as discussed with respect to operations 402 and 404. However, other workflows may be used as well. For instance, the identification of a user account may alternatively or additionally be triggered by an explicit request by the user account itself, by a systems administrator, or by another such user to materialize the user account to the software environment.

If the log in request was unsuccessful, then at 406 one or more hash values associated with the log in request are determined. Based on the one or more hash values, a determination is made at 408 as to whether the user was potentially authorized to access the first software environment based on a global filtering process. That is, the global filter may be queried based on the one or more hash values to determine whether the user account is potentially represented in the global filter.

According to various embodiments, various types of global filters may be employed. In some embodiments, the global filter may be a probabilistic filter such as a bloom filter or a cuckoo filter. For instance, a bloom filter is probabilistic in the sense that it may return a false positive value, indicating that a user account is potentially represented in the bloom filter when in fact the user account is not represented in the bloom filter.

In some embodiments, a global filter may be checked prior to checking local filters associated with individual computing environments. For instance, if the user account is not represented in the global filter, then there would be no need to check the local filters. In addition, the login request may be received at a computing environment different than that on which the user account is authorized but non-materialized may be received.

In some embodiments, the one or more hash values may be determined by applying one or more hash functions to all or a portion of the user identifier associated with the login request. For example, a username may be hashed a number of times with different hash functions to produce a number of different hash values for that username. As another example, a raw hash value produced by applying a hash function to a username may be divided into a number of portions, which may be treated as different hash values for the purpose of the filter.

According to various embodiments, the number, type, and manner of computation for the one or more hash values may depend on system characteristics. For example, increasing the size of a bloom filter reduces the false positive rate at the expense of increased storage space. As another example, the number of hash values employed may depend on characteristics such as the size of the bloom filter and the actual or anticipated number of items represented in the bloom filter.

If the user is potentially represented in the global filter, then at 410 a local filter associated with a computing environment is selected for analysis. According to various embodiments, computing environments may be selected for analysis in parallel or in sequence, and in any suitable order. As discussed herein, an on-demand computing services environment may include a number of different computing environments. A computing environment may share a variety of hardware and/or software resources among a number of different software environments. For instance, a computing environment may share one or more databases, database tables, database connections, storage systems, communications interfaces, and the like across the software environments.

A determination is made at 412 as to whether the user is potentially represented in the selected local filter. In some embodiments, the determination may be made by applying one or more hash functions to a user identifier to produce one or more hash values, and then querying the local filter using the one or more hash values, as discussed with respect to operations 406 and 408.

In some implementations, the local filter may be configured in a manner different from the global filter. For example, a global filter may be significantly larger in size than a local filter to account for the relatively larger number of non-materialized accounts represented in the global filter. As another example, the global filter may differ from the local filter in terms of the number of hash values employed, the false positive rate, and the like.

If the user is potentially represented in the selected local filter, then at 414 the computing environment is identified as potentially having authorized but not yet materialized the user account. As discussed herein, a filter may return a negative response to a query if a user account is not represented in the filter. A positive response from the filter may indicate that the user account is potentially represented in the filter. That is, the filter may occasionally return a false positive outcome.

In some embodiments, the identification of the computing environment as potentially having authorized but not yet materialized the user account may trigger a request to materialize the user to a software environment within the computing environment. In some configurations, such requests may be batched to reduce the frequency of request traffic and/or improve request processing efficiency.

A determination is made at 416 as to whether to select an additional local filter for analysis. According to various embodiments, additional local filters may continue to be selected until a triggering condition is met. For example, additional local filters may continue to be selected until all local filters have been selected. As another example, additional local filters may continue to be selected until a local filter on which the user account is potentially represented is found. As yet another example, additional local filters may continue to be selected until a computing environment on which the user account is authorized but not yet materialized is found.

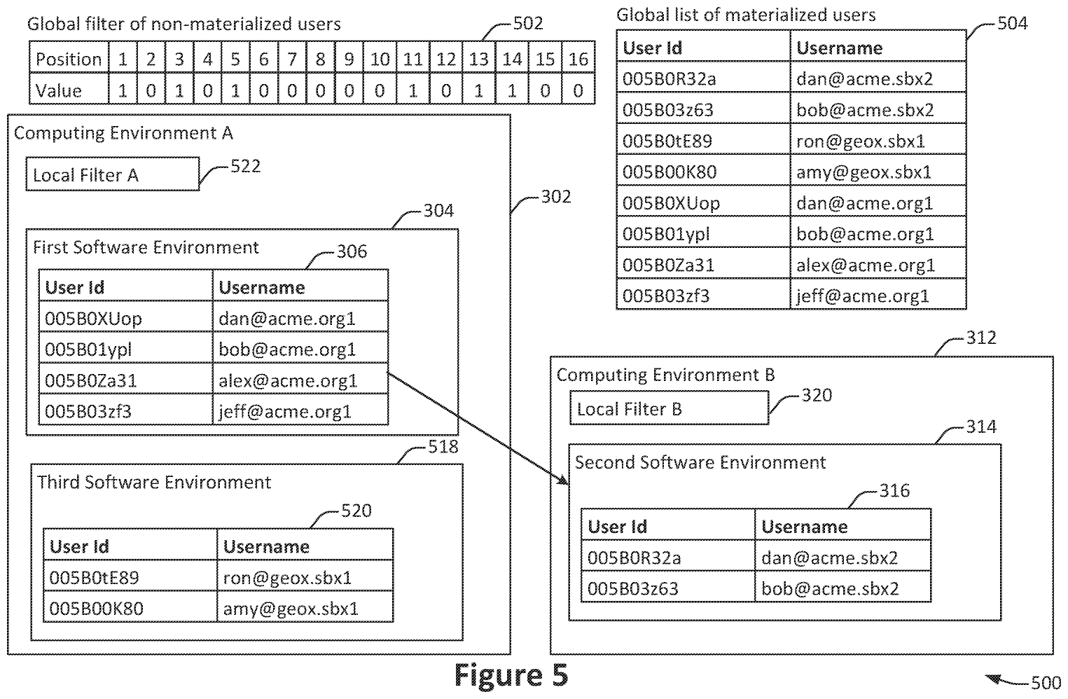

FIG. 5, which illustrates one example of a software environment filter arrangement 500, configured in accordance with one or more embodiments. FIG. 5 includes a computing environment A 302. The computing environment A 302 includes a first software environment 304, which in turn includes a set of materialized users 306. The first software environment 304 was used as a basis for creating a second software environment 314, which in turn includes a subset of materialized users 316.

According to various embodiments, a computing environment may include more than one software environment. For instance, the computing environment A 302 includes both the first software environment 304 and a third software environment 518. The third software environment 518 includes its own set of materialized users 520.

According to various embodiments, a local filter identifies the set of users authorized but not materialized to software environments within the associated computing environment. For instance, because the second software environment 314 was created based on the first software environment 304, the local filter B 320 includes the users alex@acme.sbx2 and jeff@acme.sbx2.

In some implementations, the on-demand computing services environment may maintain a global list of materialized users 504. Because an on-demand computing services environment may include many (e.g., millions, billions, or trillions) of user accounts, the global list of materialized users may be quite large. A global list of authorized but non-materialized users may in many configurations be even larger, since a software environment may be associated with potentially many replica software environments.

In some embodiments, the on-demand computing services environment may maintain a global filter of non-materialized users 502. Such a filter may require substantially less storage space, and potentially several orders of magnitude less storage space, than a global list of non-materialized users.

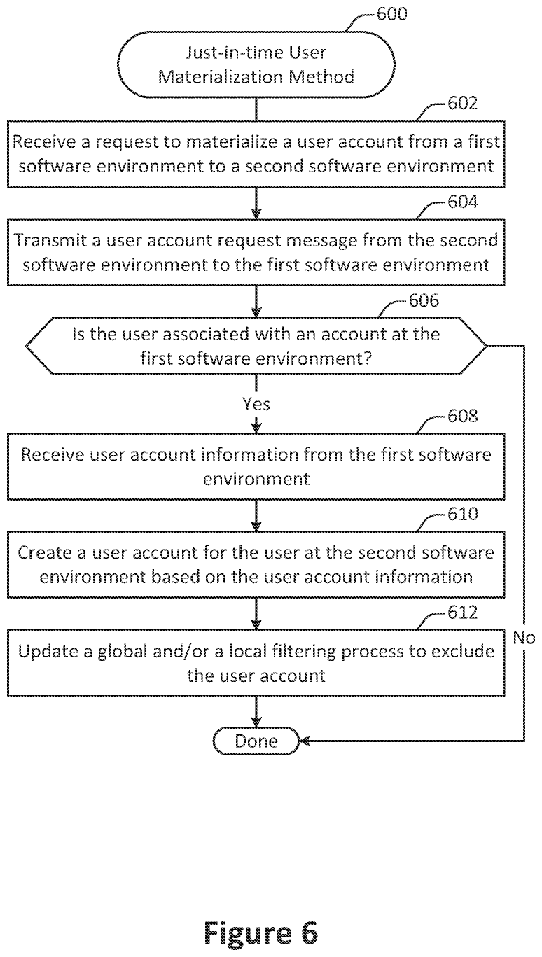

Consider the following concrete example of the method 400 shown in FIG. 4, performed in accordance with one or more embodiments. In particular, consider the example of Alex, who is associated with user ID 005B0Za31 and the username alex@acme.org1. If Alex tries to log in to the system using the username alex@acme.sbx2, her log in attempt will fail. Although she is authorized to access the second software environment 314, her account has not yet been materialized to the second software environment. After the login failure, Alex's username may be used to query the global filter of non-materialized users 502. The global filter may return an indication that Alex's username is potentially represented in the global filter. Alex's username may then be used to query one or more of the local filter A 522 and the local filter B 320. The local filter B 320 may then return an indication that Alex's username is potentially represented in the local filter. Based on this indication, a request may be transmitted to materialize Alex's user account to the second software environment 314. An example of a procedure for performing such materialization is discussed with reference to the method 600 shown in FIG. 6.

In some embodiments, one or more restrictions may be imposed on software environments. For instance, in FIG. 5, the third software environment 518 is a sandbox environment, while the first software environment 304 is a production environment. However, in some configurations, sandbox environments may be isolated from production environments, and kept in dedicated computing environments with other software environments.

FIG. 6 illustrates a just-in-time user materialization method 600, performed in accordance with one or more embodiments. In some embodiments, the method 600 may be performed in order to materialize a user account to a software environment upon request, after the software environment has been created. The method 600 may be performed at any suitable computing device, such as at one or more devices within an on-demand computing services environment as shown for instance in FIG. 9, FIG. 10A, FIG. 10B, and/or FIG. 11.

A request to materialize a user account from a first software environment to a second software environment is received at 602. In some implementations, the request may be generated when a login attempt by the user fails. For instance, the request may be generated as discussed with respect to the operation 416 shown in FIG. 4.

A user account request message is transmitted from the second software environment to the first software environment at 604. In some implementations, the request message may include information such as the identity of the user account and the identity of the second software environment. Such requests may be batched in order to reduce the number of user account request messages.

A determination is made at 606 as to whether the user account is associated with an account at the first software environment. In some implementations, the determination may be made by comparing the user account identity information transmitted at 604 with user account information stored at the first software environment. For instance, the user account identity information may be used to look up the user account in a database at the first software environment. If the user account is present, then information about the user account may be returned.

If it is determined that the user is associated with an account at the first software environment, then at 608 user account information is received from the first software environment. According to various embodiments, user account information may include information such as a username, a password, a password hash value, user account metadata information, and/or any other information related to the user account. Such information may be batched in order to reduce the number of times that user account information is transferred between systems.

In particular embodiments, user account information may be received from a source other than the first software environment. For instance, user account information may be received from a global repository that stores user account information for more than one software environment.

At 610, a user account for the user at the second software environment is created based on the user account information. In some implementations, creating the user account may involve one or more operations for updating the user information to reflect differences at the second software environment. For instance, a user account at the first software environment may include a username such as name@company.org1 that includes an element (i.e., “org1”) that is specific to the first software environment. In such a situation, the username may be updated to a different username such as name@company.sbx1 that includes a different element (i.e., “sbx1”) that is specific to the second software environment.

In some implementations, creating the user account may involve one or more operations for informing the on-demand computing service environment about the user account creation. For instance, a global repository of materialized user accounts may be updated to reflect the newly created user account.

A global and/or local filtering process is updated at 612 to exclude the user account. In some embodiments, updating a filtering process may involve recomputing the filter. For instance, to remove an entry from a bloom filter, the filter may need to be recalculated based on the existing authorized but non-materialized users. Such a process may happen periodically (e.g., every day) and/or upon detection of a triggering condition (e.g., a designated number of user accounts to be excluded from the filter.

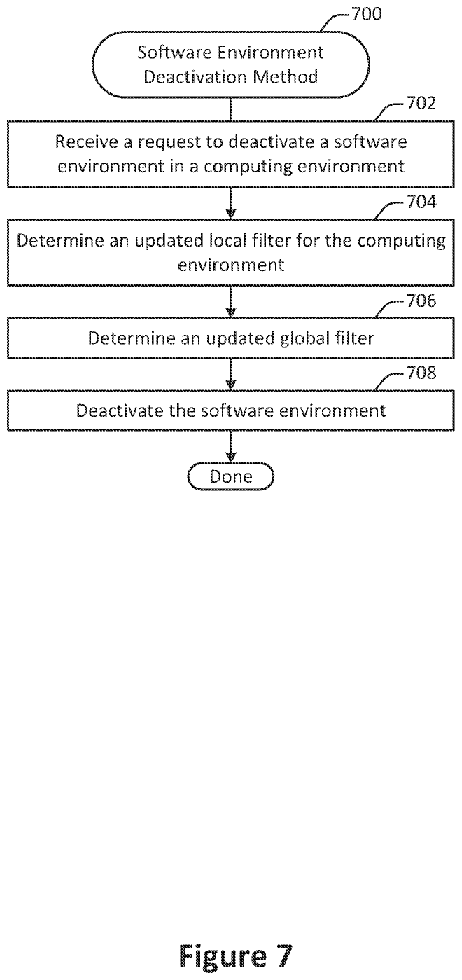

FIG. 7 illustrates a software environment deactivation method 700, performed in accordance with one or more embodiments. In some embodiments, the method 700 may be performed at a computing environment within an on-demand computing services environment. For instance, the method 700 may be performed at one or more of the components shown in FIG. 9, FIG. 10A, FIG. 10B, and/or FIG. 11.

A request to deactivate a software environment in a computing environment is received at 702. In some embodiments, the request may be generated based on user input. For instance, a systems administrator may provide a request to deactivate a software environment. Alternatively, the request may be generated programmatically. For instance, a software environment may be automatically deactivated when one or more triggering conditions are met.

An updated local filter for the computing environment is determined at 704. The local filter may be updated in order to reflect the removal of non-materialized users associated with the software environment being deactivated.

In some embodiments, an updated local filter may be determined by changing one or more values within the local filter. However, depending on the type of filter employed, the filter may need to be recomputed. For instance, a bloom filter may be updated by recomputing it based on non-materialized users associated with software environments within the computing environment other than the software environment being deactivated. Because such an operation may be computationally expensive, in some configurations the local filter may be updated periodically, at scheduled times, or when a triggering condition is met. For example, an updated local filter may be determined once per day or once per hour. As another example, an updated local filter may be determined when a designated number of software environments have been deactivated. As yet another example, an updated local filter may be determined when a designated number of non-materialized accounts have been removed.

An updated global filter is determined at 706. According to various embodiments, the global filter may be updated in a manner substantially similar to the updating of the local filter performed as discussed with respect to the operation 704.

The software environment is deactivated at 708. According to various embodiments, deactivating the software environment may involve one or more operations related to freeing computer resources for other uses. For instance, data may be deleted, connections may be freed, and/or other suitable operations may be performed.

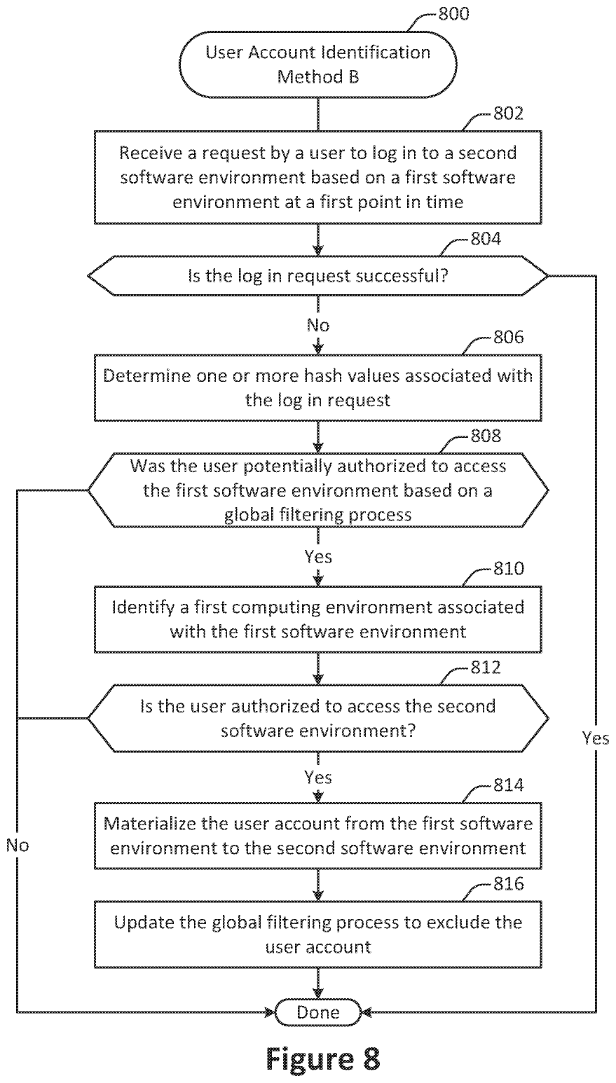

FIG. 8 illustrates a method 800 for identifying a user account, performed in accordance with one or more embodiments. According to various embodiments, the method 800 may serve as an alternative approach to the method 400 shown in FIG. 4. The method 700 may be performed at a computing environment within an on-demand computing services environment. For instance, the method 700 may be performed at one or more of the components shown in FIG. 9, FIG. 10A, FIG. 10B, and/or FIG. 11.

At 802, a request is received by a user to log in to a second software environment based on a first software environment at a first point in time. At 804, a determination is made as to whether the log in request was successful. In some embodiments, operations 802 and 804 may be substantially similar to operations 402 and 404 shown in FIG. 4.

At 806, one or more hash values associated with the log in request are determined. At 808, a determination is made as to whether the user was potentially authorized to access the first software environment based on a global filtering process. In some embodiments, operations 806 and 808 may be substantially similar to operations 406 and 408 shown in FIG. 4. However, operations 806 and 808 may exploit one or more regularities in username configuration within the on-demand computing services environment. For instance, a username such as “dan@acme.sbx1” may include a first portion (i.e., “dan@acme” in this example) that may be matched against a global filter and used to identify the first software environment, along with a second portion (i.e., sbx1 in this example) that may be used to identify the second software environment.

If the user was potentially authorized to access the first software environment based on a global filtering process, then at 810 a first computing environment associated with the first software environment is identified. In some embodiments, as discussed herein, a software environment may reside in a computing environment in which resources are shared across software environments. In some configurations, as discussed with respect to operation 806, usernames may be constructed in such a way to allow the identification of the first software environment from the username itself.

A determination is made at 812 as to whether the user is authorized to access the second software environment. In some implementations, the determination made at 812 may be made at least in part based on comparing a second portion of a username with a list of subordinate software environments associated with the first software environment. The list of subordinate software environments may include any software environments created based on the first software environment. For instance, the list of subordinate software environments may include the second software environment.

If one portion of a username indicates that the user was potentially authorized to access the first software environment and another portion of the username identifies the second software environment, then the user may need to be materialized from the first software environment to the second software environment. Accordingly, at 814, the user account is materialized from the first software environment to the second software environment. In some embodiments, the materialization of the user account from the first software environment from the second software environment may be conducted as discussed with respect to the method 600 shown in FIG. 6.

The global filtering process is updated at 816 to exclude the user account. In some embodiments, updating the global filtering process may involve recomputing the filter. For instance, to remove an entry from a bloom filter, the filter may need to be recalculated based on the existing authorized but non-materialized users. Such a process may happen periodically (e.g., every day) and/or upon detection of a triggering condition (e.g., a designated number of user accounts to be excluded from the filter.

FIG. 9 shows a block diagram of an example of an environment 910 that includes an on-demand database service configured in accordance with some implementations. Environment 910 may include user systems 912, network 914, database system 916, processor system 917, application platform 918, network interface 920, tenant data storage 922, tenant data 923, system data storage 924, system data 925, program code 926, process space 928, User Interface (UI) 930, Application Program Interface (API) 932, PL/SOQL 934, save routines 936, application setup mechanism 938, application servers 950-1 through 950-N, system process space 952, tenant process spaces 954, tenant management process space 960, tenant storage space 962, user storage 964, and application metadata 966. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 916, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 918 may be a framework that allows the creation, management, and execution of applications in system 916. Such applications may be developed by the database service provider or by users or third-party application developers accessing the service. Application platform 918 includes an application setup mechanism 938 that supports application developers' creation and management of applications, which may be saved as metadata into tenant data storage 922 by save routines 936 for execution by subscribers as one or more tenant process spaces 954 managed by tenant management process 960 for example. Invocations to such applications may be coded using PL/SOQL 934 that provides a programming language style interface extension to API 932. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 966 for a subscriber making such an invocation. Such system processes may also manage execution of application metadata 966 as an application in a virtual machine.

In some implementations, each application server 950 may handle requests for any user associated with any organization. A load balancing function (e.g., an F5 Big-IP load balancer) may distribute requests to the application servers 950 based on an algorithm such as least-connections, round robin, observed response time, etc. Each application server 950 may be configured to communicate with tenant data storage 922 and the tenant data 923 therein, and system data storage 924 and the system data 925 therein to serve requests of user systems 912. The tenant data 923 may be divided into individual tenant storage spaces 962, which can be either a physical arrangement and/or a logical arrangement of data. Within each tenant storage space 962, user storage 964 and application metadata 966 may be similarly allocated for each user. For example, a copy of a user's most recently used (MRU) items might be stored to user storage 964. Similarly, a copy of MRU items for an entire tenant organization may be stored to tenant storage space 962. A UI 930 provides a user interface and an API 932 provides an application programming interface to system 916 resident processes to users and/or developers at user systems 912.

System 916 may implement a web-based software environment system. For example, in some implementations, system 916 may include application servers configured to implement and execute software applications for creating sandboxes or other derivative software environments based on a source software environment. The application servers may be configured to provide related data, code, forms, web pages and other information to and from user systems 912. Additionally, the application servers may be configured to store information to, and retrieve information from a database system. Such information may include related data, objects, and/or Webpage content. With a multi-tenant system, data for multiple tenants may be stored in the same physical database object in tenant data storage 922, however, tenant data may be arranged in the storage medium(s) of tenant data storage 922 so that data of one tenant is kept logically separate from that of other tenants. In such a scheme, one tenant may not access another tenant's data, unless such data is expressly shared.

Several elements in the system shown in FIG. 9 include conventional, well-known elements that are explained only briefly here. For example, user system 912 may include processor system 912A, memory system 912B, input system 912C, and output system 912D. A user system 912 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 912 to access, process and view information, pages and applications available from system 916 over network 914. Network 914 may be any network or combination of networks of devices that communicate with one another, such as any one or any combination of a LAN (local area network), WAN (wide area network), wireless network, or other appropriate configuration.

The users of user systems 912 may differ in their respective capacities, and the capacity of a particular user system 912 to access information may be determined at least in part by “permissions” of the particular user system 912. As discussed herein, permissions generally govern access to computing resources such as data objects, components, and other entities of a computing system, such as a software environment, a social networking system, and/or a CRM database system. “Permission sets” generally refer to groups of permissions that may be assigned to users of such a computing environment. For instance, the assignments of users and permission sets may be stored in one or more databases of System 916. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 916 may provide on-demand database service to user systems 912 using an MTS arrangement. By way of example, one tenant organization may be a company that employs a sales force where each salesperson uses system 916 to manage their sales process. Thus, a user in such an organization may maintain contact data, leads data, customer follow-up data, performance data, goals and progress data, etc., all applicable to that user's personal sales process (e.g., in tenant data storage 922). In this arrangement, a user may manage his or her sales efforts and cycles from a variety of devices, since relevant data and applications to interact with (e.g., access, view, modify, report, transmit, calculate, etc.) such data may be maintained and accessed by any user system 912 having network access.

When implemented in an MTS arrangement, system 916 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 916 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 916 may also maintain system-level data usable by multiple tenants or other data. Such system-level data may include industry reports, news, postings, and the like that are sharable between tenant organizations.

In some implementations, user systems 912 may be client systems communicating with application servers 950 to request and update system-level and tenant-level data from system 916. By way of example, user systems 912 may send one or more queries requesting data of a database maintained in tenant data storage 922 and/or system data storage 924. An application server 950 of system 916 may automatically generate one or more SQL statements (e.g., one or more SQL queries) that are designed to access the requested data. System data storage 924 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

FIG. 10A shows a system diagram of an example of architectural components of an on-demand database service environment 1000, configured in accordance with some implementations. A client machine located in the cloud 1004 may communicate with the on-demand database service environment via one or more edge routers 1008 and 1012. A client machine may include any of the examples of user systems ?12 described above. The edge routers 1008 and 1012 may communicate with one or more core switches 1020 and 1024 via firewall 1016. The core switches may communicate with a load balancer 1028, which may distribute server load over different pods, such as the pods 1040 and 1044 by communication via pod switches 1032 and 1036. The pods 1040 and 1044, which may each include one or more servers and/or other computing resources, may perform data processing and other operations used to provide on-demand services. Components of the environment may communicate with a database storage 1056 via a database firewall 1048 and a database switch 1052.

Accessing an on-demand database service environment may involve communications transmitted among a variety of different components. The environment 1000 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 10A and 10B.

The cloud 1004 refers to any suitable data network or combination of data networks, which may include the Internet. Client machines located in the cloud 1004 may communicate with the on-demand database service environment 1000 to access services provided by the on-demand database service environment 1000. By way of example, client machines may access the on-demand database service environment 1000 to retrieve, store, edit, and/or process user account information.

In some implementations, the edge routers 1008 and 1012 route packets between the cloud 1004 and other components of the on-demand database service environment 1000. The edge routers 1008 and 1012 may employ the Border Gateway Protocol (BGP). The edge routers 1008 and 1012 may maintain a table of IP networks or ‘prefixes’, which designate network reachability among autonomous systems on the internet.

In one or more implementations, the firewall 1016 may protect the inner components of the environment 1000 from internet traffic. The firewall 1016 may block, permit, or deny access to the inner components of the on-demand database service environment 1000 based upon a set of rules and/or other criteria. The firewall 1016 may act as one or more of a packet filter, an application gateway, a stateful filter, a proxy server, or any other type of firewall.

In some implementations, the core switches 1020 and 1024 may be high-capacity switches that transfer packets within the environment 1000. The core switches 1020 and 1024 may be configured as network bridges that quickly route data between different components within the on-demand database service environment. The use of two or more core switches 1020 and 1024 may provide redundancy and/or reduced latency.

In some implementations, communication between the pods 1040 and 1044 may be conducted via the pod switches 1032 and 1036. The pod switches 1032 and 1036 may facilitate communication between the pods 1040 and 1044 and client machines, for example via core switches 1020 and 1024. Also or alternatively, the pod switches 1032 and 1036 may facilitate communication between the pods 1040 and 1044 and the database storage 1056. The load balancer 1028 may distribute workload between the pods, which may assist in improving the use of resources, increasing throughput, reducing response times, and/or reducing overhead. The load balancer 1028 may include multilayer switches to analyze and forward traffic.

In some implementations, access to the database storage 1056 may be guarded by a database firewall 1048, which may act as a computer application firewall operating at the database application layer of a protocol stack. The database firewall 1048 may protect the database storage 1056 from application attacks such as structure query language (SQL) injection, database rootkits, and unauthorized information disclosure. The database firewall 1048 may include a host using one or more forms of reverse proxy services to proxy traffic before passing it to a gateway router and/or may inspect the contents of database traffic and block certain content or database requests. The database firewall 1048 may work on the SQL application level atop the TCP/IP stack, managing applications' connection to the database or SQL management interfaces as well as intercepting and enforcing packets traveling to or from a database network or application interface.

In some implementations, the database storage 1056 may be an on-demand database system shared by many different organizations. The on-demand database service may employ a single-tenant approach, a multi-tenant approach, a virtualized approach, or any other type of database approach. Communication with the database storage 1056 may be conducted via the database switch 1052. The database storage 1056 may include various software components for handling database queries. Accordingly, the database switch 1052 may direct database queries transmitted by other components of the environment (e.g., the pods 1040 and 1044) to the correct components within the database storage 1056.

FIG. 10B shows a system diagram further illustrating an example of architectural components of an on-demand database service environment, in accordance with some implementations. The pod 1044 may be used to render services to user(s) of the on-demand database service environment 1000. The pod 1044 may include one or more content batch servers 1064, content search servers 1068, query servers 1082, file servers 1086, access control system (ACS) servers 1080, batch servers 1084, and app servers 1088. Also, the pod 1044 may include database instances 1090, quick file systems (QFS) 1092, and indexers 1094. Some or all communication between the servers in the pod 1044 may be transmitted via the switch 1036.

In some implementations, the app servers 1088 may include a framework dedicated to the execution of procedures (e.g., programs, routines, scripts) for supporting the construction of applications provided by the on-demand database service environment 1000 via the pod 1044. One or more instances of the app server 1088 may be configured to execute all or a portion of the operations of the services described herein.

In some implementations, as discussed above, the pod 1044 may include one or more database instances 1090. A database instance 1090 may be configured as an MTS in which different organizations share access to the same database, using the techniques described above. Database information may be transmitted to the indexer 1094, which may provide an index of information available in the database 1090 to file servers 1086. The QFS 1092 or other suitable filesystem may serve as a rapid-access file system for storing and accessing information available within the pod 1044. The QFS 1092 may support volume management capabilities, allowing many disks to be grouped together into a file system. The QFS 1092 may communicate with the database instances 1090, content search servers 1068 and/or indexers 1094 to identify, retrieve, move, and/or update data stored in the network file systems (NFS) 1096 and/or other storage systems.

In some implementations, one or more query servers 1082 may communicate with the NFS 1096 to retrieve and/or update information stored outside of the pod 1044. The NFS 1096 may allow servers located in the pod 1044 to access information over a network in a manner similar to how local storage is accessed. Queries from the query servers 1022 may be transmitted to the NFS 1096 via the load balancer 1028, which may distribute resource requests over various resources available in the on-demand database service environment 1000. The NFS 1096 may also communicate with the QFS 1092 to update the information stored on the NFS 1096 and/or to provide information to the QFS 1092 for use by servers located within the pod 1044.

In some implementations, the content batch servers 1064 may handle requests internal to the pod 1044. These requests may be long-running and/or not tied to a particular customer, such as requests related to log mining, cleanup work, and maintenance tasks. The content search servers 1068 may provide query and indexer functions such as functions allowing users to search through content stored in the on-demand database service environment 1000. The file servers 1086 may manage requests for information stored in the file storage 1098, which may store information such as documents, images, basic large objects (BLOBs), etc. The query servers 1082 may be used to retrieve information from one or more file systems. For example, the query system 1082 may receive requests for information from the app servers 1088 and then transmit information queries to the NFS 1096 located outside the pod 1044. The ACS servers 1080 may control access to data, hardware resources, or software resources called upon to render services provided by the pod 1044. The batch servers 1084 may process batch jobs, which are used to run tasks at specified times. Thus, the batch servers 1084 may transmit instructions to other servers, such as the app servers 1088, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

FIG. 11 illustrates one example of a computing device. According to various embodiments, a system 1100 suitable for implementing embodiments described herein includes a processor 1101, a memory module 1103, a storage device 1105, an interface 1111, and a bus 1115 (e.g., a PCI bus or other interconnection fabric.) System 1100 may operate as variety of devices such as an application server, a database server, or any other device or service described herein. Although a particular configuration is described, a variety of alternative configurations are possible. The processor 1101 may perform operations such as those described herein. Instructions for performing such operations may be embodied in the memory 1103, on one or more non-transitory computer readable media, or on some other storage device. Various specially configured devices can also be used in place of or in addition to the processor 1101. The interface 1111 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A method for authorizing users to access a second software environment with a second limited set of authorized users wherein the second software environment includes at a first point in time prior to the user access a subset of a first software environment that includes at the first point in time a first set of authorized users that was a superset of the second limited set and wherein the method comprises:
determining via a first processor and a global filtering process with at least one first hash value associated with a login attempt by a first user whether the first user has potentially been a member of the first set of authorized users;
determining via a second processor whether the user has been a member of the first set of authorized users when it is determined by the first processor that the first user has potentially been a member of the first set of authorized users; and
when it is determined by the second processor that the user has been a member of the first set of authorized users, causing the transmission of account information associated with the first user and at least the first software environment through a communication link to the second software environment.

2. The method of claim 1, wherein the method further includes determining via a third processor and a local filtering process with a second hash value whether the first user has potentially been a member of the first set of authorized users.

3. The method of claim 2, wherein the method further includes adding the first user to the second limited set as an authorized user of the second software environment and updating a local filter to exclude the first user.

4. The method of claim 2, wherein the local filtering process includes accessing a local filter implemented as a bloom filter or a cuckoo filter.

5. The method of claim 4, wherein the updating the local filter comprises updating the local filter based on a plurality of hash values associated with the first user.

6. The method of claim 2, wherein the local filtering process is performed when it is determined via the global filtering process that the first user has potentially been a member of the first set of authorized users.

7. The method of claim 2, wherein the method further includes determining whether the first user has been a member of the first set of authorized users when it is determined by the first processor and the second processor that the first user has potentially been a member of the first set of authorized users.

8. The method of claim 1, wherein the global filtering process is conducted via a global filter associated with a plurality of software environments including the first software environment, the second software environment, and a third software environment.

9. The method of claim 8, wherein the global filter is a bloom filter or a cuckoo filter, and wherein the method further includes updating the global filter to include the first user.

10. The method of claim 1, wherein the first software environment and the second software environment reside in an on-demand computing services environment that includes a plurality of software environments in addition to the first software environment and the second software environment.

11. The method of claim 10, wherein the first software environment resides in a first computing environment within the on-demand computing services environment, and wherein the second software environment resides in a second computing environment within the on-demand computing services environment, and wherein a local filtering process is conducted via a local filter specific to the second computing environment.

12. The method of claim 11, wherein the second computing environment includes a plurality of computing resources shared by the second software environment and a third software environment.

13. The method of claim 11, wherein the global filtering process includes a global filter that includes users of the first computing environment and the second computing environment.

14. The method of claim 11, wherein the global filtering process involves applying a global filter to a first portion of a username associated with the first user.

15. The method of claim 14, wherein determining via a second processor whether the first user has been a member of the first set of authorized users involves matching a second portion of a username associated with the first user against a list of subordinate computing environments associated with the first computing environment, the list of subordinate computing environments including the second computing environment.

16. A system configured to perform a method for authorizing users to access a second software environment with a second limited set of authorized users wherein the second software environment includes at a first point in time prior to the user access a subset of a first software environment that includes at the first point in time a first set of authorized users that was a superset of the second limited set and wherein the method comprises:
determining via a first processor and a global filtering process with at least one first hash value associated with a login attempt by a first user whether the first user has potentially been a member of the first set of authorized users;
determining via a second processor whether the user has been a member of the first set of authorized users when it is determined by the first processor that the first user has potentially been a member of the first set of authorized users; and
when it is determined by the second processor that the user has been a member of the first set of authorized users, causing the transmission of account information associated with the first user and at least the first software environment through a communication link to the second software environment.

17. The system of claim 16, wherein the method further includes determining via a third processor and a local filtering process with a second hash value whether the first user has potentially been a member of the first set of authorized users.

18. The system of claim 17, wherein the method further includes adding the first user to the second limited set as an authorized user of the second software environment and updating a local filter to exclude the first user.

19. One or more non-transitory computer-readable media having instructions stored thereon for performing a method for authorizing users to access a second software environment with a second limited set of authorized users wherein the second software environment includes at a first point in time prior to the user access a subset of a first software environment that includes at the first point in time a first set of authorized users that was a superset of the second limited set and wherein the method comprises:
determining via a first processor and a global filtering process with at least one first hash value associated with a login attempt by a first user whether the first user has potentially been a member of the first set of authorized users;
determining via a second processor whether the user has been a member of the first set of authorized users when it is determined by the first processor that the first user has potentially been a member of the first set of authorized users; and
when it is determined by the second processor that the user has been a member of the first set of authorized users, causing the transmission of account information associated with the first user and at least the first software environment through a communication link to the second software environment.

20. The one or more non-transitory computer-readable media of claim 19, wherein the method further includes determining via a third processor and a local filtering process with a second hash value whether the first user has potentially been a member of the first set of authorized users, adding the first user to the second limited set as an authorized user of the second software environment, and updating a local filter to exclude the first user.
